(19) United States
(12) Patent Application Publication
(10) Pub. No.: US 2003/0101167 A1
(43) Pub. Date: May 29, 2003

(54) File maintenance on a computer grid

(75) Inventor: Viktors Berstis, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 09/997,916

(22) Filed: Nov. 29, 2001

(51) Int. Cl. G06F 7/00

(52) U.S. Cl. 707/3

(57) ABSTRACT

The invention provides a method and a computer usable medium including a program for maintaining files on a computer grid. At least one member of the computer grid is detected. A usage profile of the member is determined. A fingerprint is determined for files stored on the member. The fingerprint is stored with an associated file name in a database. A maintenance function is performed based on the database.

### TECHNICAL FIELD OF THE INVENTION

The present invention relates generally to computer systems and in particular to file maintenance on a networked computer grid.

### BACKGROUND OF THE INVENTION

With the prevalence of computers with large hard drive-type disks, networked together in some manner, it becomes exceedingly difficult to manage the systems from a storage point of view. For example, with the enormous disk capacities available today (80 gigabytes and larger), users may quickly fill the disks and not have the means to eliminate duplicate files. Furthermore, as files are copied among the computers on a networked grid, many identical file copies may be unnecessarily present on multiple network drives. Storing files in this manner on a user or networked disks wastes value storage space and may also lead to reduced disk performance. Therefore, it would be desirable to eliminate unnecessary duplicate files present on the user and network disks.

While modern hard disk drives are quite reliable compared to just a few years ago, they sometimes acquire data faults. Some sectors may become unreadable and, thus, portions of files not examined for an extended period of time may become corrupt. Recovering corrupt files may become problematic because they often are assigned new dates and times on other copies, even though the content is the same. Locating all potential recovery copies among the computer network may be extremely time consuming. In addition, the archiving/recovery process may require a level of expertise or attention to detail that a typical user may not possess. Therefore, it would be desirable to provide a simple and effective strategy for archiving/recovering files on the user and networks disks.

Many computer disk maintenance functions require numerous disk accesses. The result may be a significant disruption to the normal operation and performance of the computer system. Given that most computer systems are not in continual use, it would be more desirable to perform such functions during “off-peak” usage times.

Therefore, it would be desirable to provide a strategy for file maintenance on a computer network that would overcome the aforementioned and other disadvantages.

### SUMMARY OF THE INVENTION

One aspect of the present invention provides a method for maintaining files on a computer grid. At least one member of the computer grid is detected. A usage profile of the member is determined. A fingerprint is determined for files stored on the member. The fingerprint is stored with an associated file name in a database. A maintenance function is performed based on the database. The database may include at least one file characteristic. The file characteristic may be selected from a group consisting of a file location, a file time, and a file size. At least one exempt member may be identified wherein the exempt member may be exempt from the maintenance function. Performing the maintenance function may include: determining a storage file and archiving the storage file; determining an unnecessary file based on the database and deleting the unnecessary file; determining a corrupt file based on the fingerprint and repairing the corrupt file; determining, locating, and restoring a tagged file; determining a member disk capacity and performing the maintenance function based on the member disk capacity; and determining an optimal maintenance time of the member disk based on the usage profile and performing the maintenance function at the optimal maintenance time.

Another aspect of the present invention provides a computer usable medium including a program for maintaining files on a computer grid: computer readable program code for detecting at least one member of the computer grid; computer readable program code for determining a usage profile of the member; computer readable program code for determining a fingerprint for files stored on the member; computer readable program code for storing the fingerprint with an associated file name in a database; and computer readable program code for performing a maintenance function based on the database.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a pictorial diagram of a plurality of computers interconnected to form a network;

FIG. 2 is a flow chart of a file maintenance algorithm made in accordance with the present invention;

FIG. 3 is a representative fingerprint database made in accordance with the present invention; and

FIG. 4 is a block diagram of several file maintenance functions made in accordance with the present invention.

### DETAILED DESCRIPTION OF THE PRESENTLY PREFERRED EMBODIMENTS

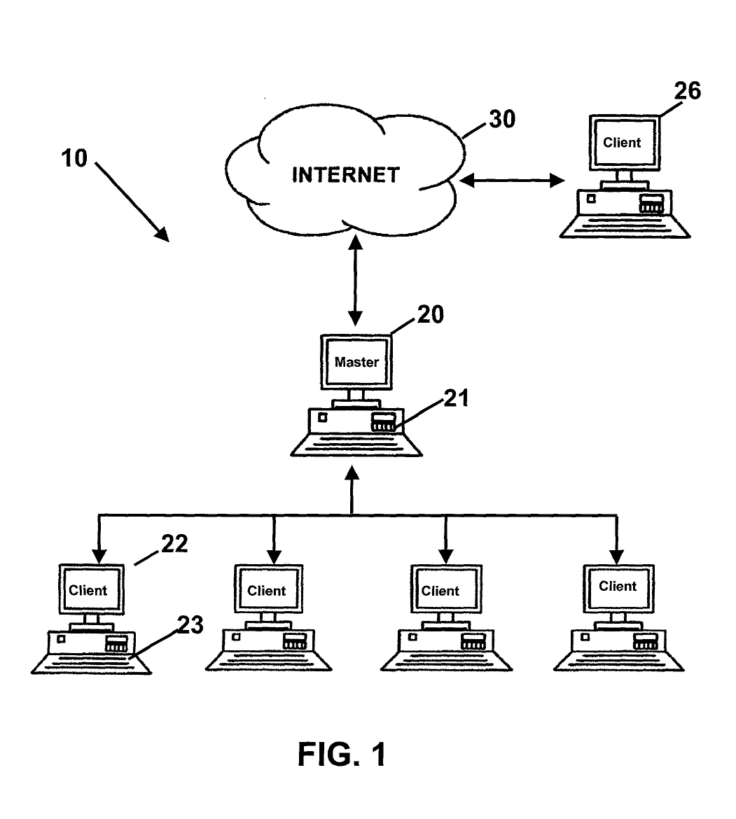

One embodiment of a computer network utilizing the present invention is shown generally in FIG. 1 as numeral 10. The computer network 10 may include a master computer 20 and a plurality of client computers 22. The master computer 20 may be electronically connected the client computers 22, forming a local area network (LAN). The master computer 20 may also be electronically connected to at least one client computer 26 through the Internet 30, forming a wide area network (WAN).

The master computer 20 and client computers 22 may include at least one master disk 21 and at least one client disk 23, respectively. Furthermore, the master computer 20 may include additional disks designed for storing archived data. The master disk 21 and the client disk 23 may include any number of storage devices capable of reading, writing, and storing data known in the art. For the purposes of this description, the term “disk” may refer to any type of storage media including, but not limited to, magnetic disk drives (e.g. hard and floppy), optical drives (e.g. CDROM, DVD, CDR, CDRW, etc.), magnetic tape, holographic storage, paper tape, punched cards, printed and the like.

In one embodiment, the master disk 21 and the client disk 23 may include large hard drive-type disks. For example, hard drive disks having storage capacities of 80 gigabytes or larger may be included. The master disk 21 and the client disk 23 may contain stored data information in the form of files. The files may additionally include characteristic information of the data. In one embodiment, the characteristic information may include a file name, file location, file time, and file size.

As discussed herein, the client computer 22 is an electronic system that requires disk maintenance and the master computer 20 directs maintenance procedures. A user is defined as an entity interacting with the master computer 20, master program, client computer 22, or client program and may include a system administrator. The collection of networked computers participating in a joint maintenance mechanism described herein is referred to as a “grid”. Those skilled in the art will recognize that the present invention may be effectively used with a variety of computer network configurations and that the present grid description is not intended to be absolute. Numerous modifications, substitutions, and departures from the grid may be made without limiting the function of the invention. For example, the invention may be used on a grid of client computers 22, without the presence of the master computer 20. The use of the master computer 20, however, may provide convenient and unobtrusive means for implementing the invention.

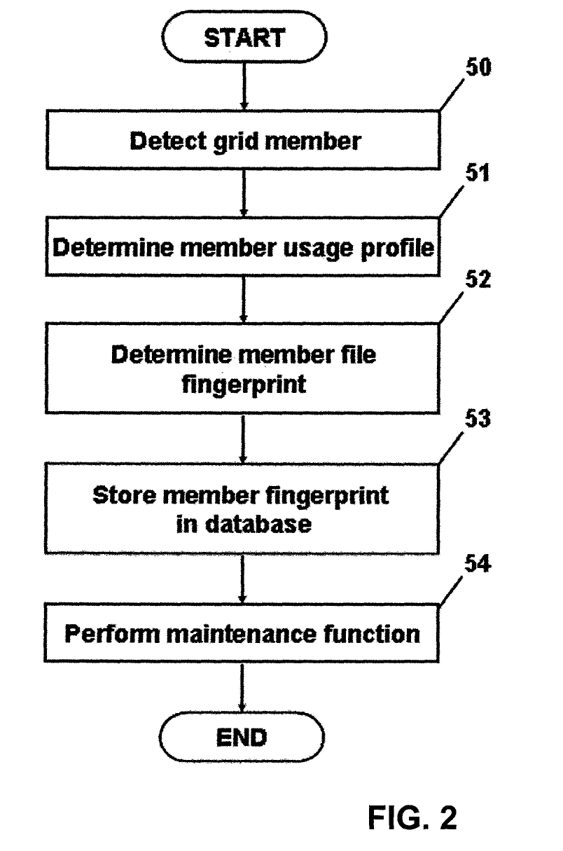

FIG. 2 is a flow chart of a file maintenance algorithm made in accordance with the present invention. In one embodiment, the algorithm may be written in computer readable program code run by the master computer. This algorithm is referred herein to as master program. Furthermore, the client computer may run a portion of the algorithm, such as an applet, to correspond with the master program. This algorithm portion is referred to as client program. The master computer and master program may be in communication with the client computer and client program either locally through a LAN or Internet, as through a WAN. At any point of the master and client programs, decisions and functions may be controlled and performed manually by the user (i.e. through mouse/keyboard input at the master or client computer) or automatically (i.e. through the programmed algorithm).

The file maintenance algorithm may begin wherein at least one member of the computer grid is detected (step 50). In the following description, the member is a master or client computer designated to participate in file maintenance procedures. The client computer may be enabled to participate as a grid member by any number of means. In one embodiment, a simple client enrollment program may be installed on the client disk, as from a diskette, CD-ROM, download, or the like. The master program may detect one or more participating client computers using a broadcast mechanism that communicates with the client's enrollment program. The broadcast mechanism may include an electronic query made by the master program to individual client programs. Additionally, the broadcast mechanism may include the enrollment program contacting the master program. An option may be provided through a user interface with the master and client programs for the client computer and for its associated files to participate in or to be exempt from file maintenance procedures.

A usage profile of the member is determined (step 51). In one embodiment, user activity of participating client computers may be monitored by the master program. In another embodiment, the user activity is monitored by the client program. The user activity may include information of any number of computer functions that correlate with computer usage. For example, hard drive accesses, keyboard input, and mouse movement may individually or collectively indicate computer usage. The computer usage may further include corresponding usage time of day, day of week, holiday and other notable or configurable time event information. The usage profile permits the master program to perform maintenance functions when normal client activity is low. Therefore, disruptions in client computer performance may be minimized.

In one embodiment, the user activity information may be stored in an activity database stored on the master and/or client computer disks. The usage profile, then, may include the compiled client computer user activity information stored in the activity database. The activity database may include fields for member computers identity associated with date and times of computer usage. The computer usage may include a percentage of disk and CPU activity or any of the other aforementioned quantifiable indicators of computer usage. As such, a running usage register may be compiled for a grid member thereby facilitating predictions of future usage patterns.

A fingerprint is determined for files stored on the member (step 52). In one embodiment, the fingerprint may be produced by a cyclic redundancy check (CRC) process known in the art. The CRC performs a mathematical calculation on a block of data (e.g. a file) and returns a fingerprint that represents the content and organization of that data. Ideally, the CRC value uniquely identifies the data much like a “fingerprint”. Any change in content of the file should produce a different CRC value thereby differentiating original and modified files. Specifically, when a CRC value is used as the fingerprint, it is preferable to include the size of the file as the initial part of the data to be processed using the CRC algorithm; otherwise, files that are of different lengths but contain all zeros may produce the same fingerprint value. The CRC process may exclude the file characteristic information (e.g. file name, file location, and file time), which allows equivalent CRC fingerprint calculations for like files with different names, locations, or date and time.

In one embodiment, a CRC fingerprint may be produced for designated files on the client disk. The fingerprint may include a 64-bit CRC value thereby making it highly improbable that two files had the same CRC (less than 1 chance in 10¹⁸). In another embodiment, two different 64-bit fingerprints may be determined for a given file using different CRC polynomials. This would make it even less likely for two files to share the same fingerprint. In another embodiment, other encryption or hashing algorithms such as SHA-1 (Secure Hash Algorithm standard) may be used to form a fingerprint for the files, rather than using CRC algorithms.

In one embodiment, the fingerprint may be determined at a time when the grid member is expected to be generally idle as per its usage profile. Additionally, the determination may occur if some other condition were true. One such condition may be if any of the following described procedural steps have not been performed for more than “x” amount of time since prior such activity. In such an instance, the determination may be forced regardless of concurrent activity on the grid member. For example, the variable “x” may be a configurable time parameter for the given grid member or for the grid as a whole.

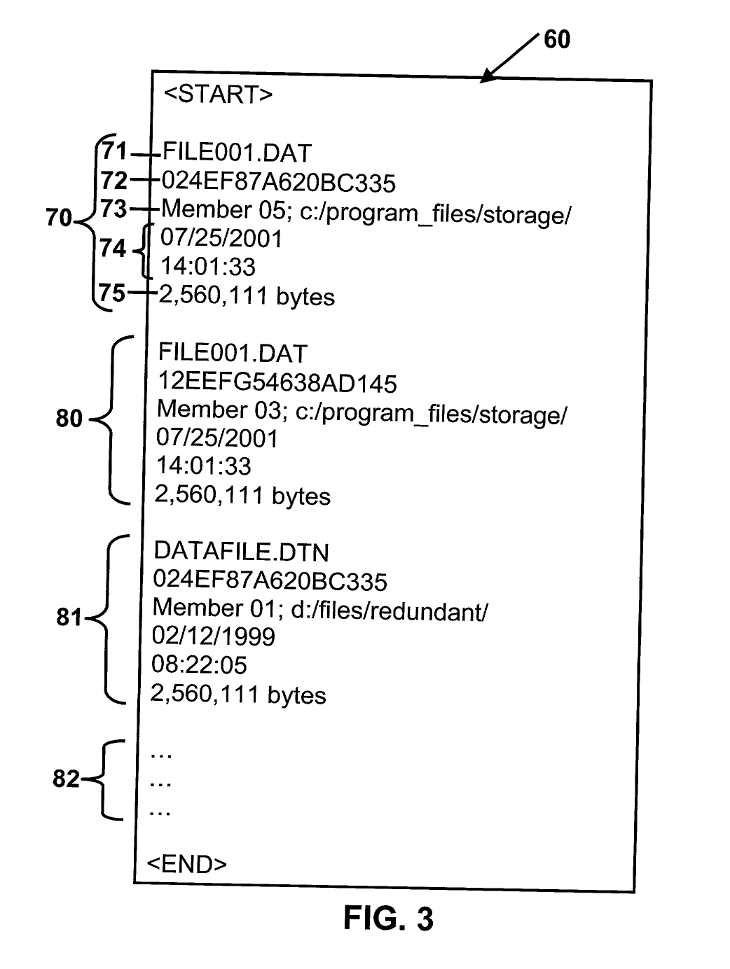

After the fingerprint has been generated, the fingerprint is stored with an associated file name in a fingerprint database (step 53). FIG. 3 is a representative fingerprint database made in accordance with the present invention. In one embodiment, the fingerprint database 60 may include a file name 71 and a corresponding fingerprint 72 for the file 70. The file name 71 may be a fully qualified name including file characteristics specific for the file 70. The file characteristics may include a file location 73, a file time 74, and a file size 75. For the purposes of this description, “file time” refers to the last modification time and date for the given file. Other times such as the time of last access, time of creation, time of deletion may also be stored in the data base entry for the file, each of which can be useful for various maintenance functions.

The fingerprint database 60 may include such entries for a plurality of files 80, 81, and 82. The fingerprint database 60 may be stored on the master and/or client disks for access by the master program. Furthermore, the fingerprint database may be stored redundantly on distinct disks so that damage to any copy of the database would not disable the ability to perform any of the maintenance functions.

Referring again to FIG. 2, a maintenance function is performed based on the fingerprint database (step 54). After the maintenance function has been performed, the master computer program may revert to any of the aforementioned algorithm steps (step 50-54). For example, the master program may rescan client drive files as needed to update the fingerprint database. Optionally, the user may provide scheduling parameters that direct the frequency of maintenance functions.

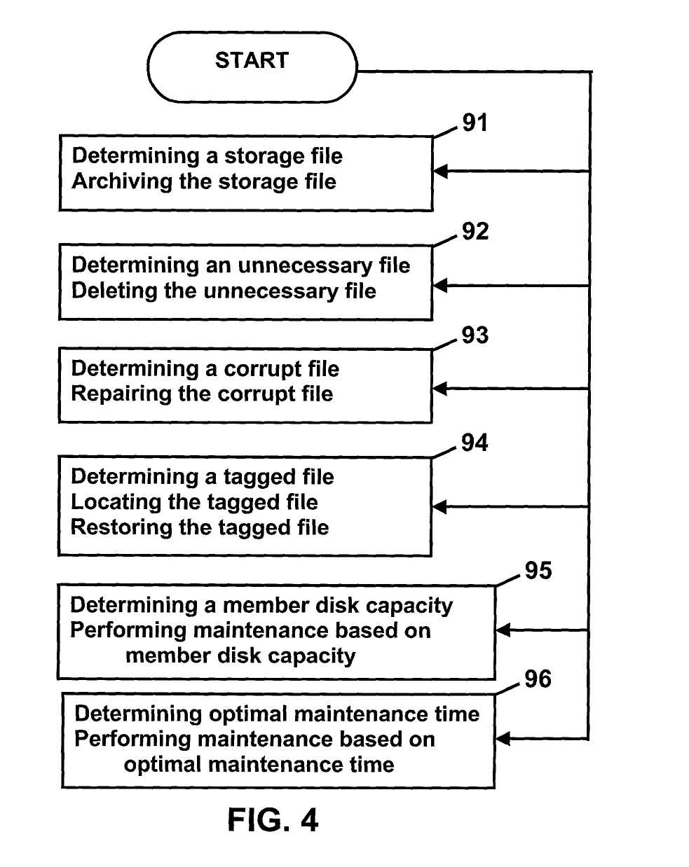

As further shown in FIG. 4, several maintenance functions may be performed on the client computer files. One maintenance function includes a file archiving function (step 91). The file archiving function provides a simple and effective strategy for archiving files on the client and grid member disks. In one embodiment, a determination may be made as to whether a file copy should be stored at an additional location. The determination may be made by consulting the fingerprint database. If a given fingerprint value appears only once, then there is only one copy of that file in the grid of computers. Thus, an additional copy of the file should be made to provide redundancy. If a given fingerprint value appears multiple times in the database, but all of the instances are on the same disk, an additional copy of that file may be made on another disk in the grid. Additionally, the determination may be made by the user or the master/client program. The designated storage file may then be archived at an additional location on the grid. Archiving may include any number of methods standard in the art to produce a file archive.

In another embodiment, the file archiving maintenance function may make a copy of a specified file on another member's disk. The function may be governed according to user activity information specified in the activity database. For example, a file may be copied on a disk that has excess available space or a disk that is not often otherwise utilized as per the usage profile information gathered in step 51.

In another embodiment, the master program may instruct the client programs to watch for changes in frequently changing files (such as a registry) and make timely backups of those files or any other critical files (such as system files).

In another embodiment, an application program interface (API) may be provided for applications to designate files to be backed up simultaneously by the file archiving function. This may be achieved by using system locking or semaphore mechanisms so that the copies can be made from a consistent set of source files. Furthermore, this may be achieved without concern for modifications that would have made the set of files inconsistent in some manner.

In another embodiment, certain files generally known to be temporary in nature would not require backup copies. The temporary files may be specified for particular operating systems, application programs, caches or other situations as rules for identifying such files. The rules governing archiving function may be specified in terms of directory locations, patterns matching files names, lists of specific files, and the like.

Another maintenance function includes a redundancy check function (step 92). In one embodiment, a determination may be made as to whether a file is unnecessary. The determination may be made by the user or the master/client program. Multiple copies of a given file present on one or more client computer disks may represent unnecessary files. For example, the given file may be needed as only one or two copies within the computer grid. Referring again to FIG. 3, the given file 70 has an identical fingerprint with file 81, although the file name, file location, and file time differ. In such an instance, the file 81 may be marked unnecessary as it is the same as the given file 70. The unnecessary file 81 may then be deleted thereby liberating disk space. As such, the redundancy check function provides means for eliminating unnecessary duplicate files present on the client and grid member disks.

In one embodiment, the user may view the fingerprint database to determine those files that are obsolete or that occupy excessive space. These files may then be designated for deletion or backup thereby liberating disk space.

In another embodiment, computer systems supporting symbolic links (e.g. Unix or Linux systems) in a file system may convert excessive file copies into symbolic links. This may save a great deal of disk space, while leaving at least two distinct copies of the file. Sometimes users make multiple backup copies of a large directory of files because they intend to modify the original directory in some manner and wish to have a backup. The above maintenance function would be able to automatically “prune” excess duplicate files from such backup directories while ensuring that there are at least two distinct copies of any given file in the grid. Sometimes multiple copies of files must be permitted in the grid because every grid member requires local use of such files. Examples include operating system files, application programs, and certain other files. These files may be specified to not be deleted by the maintenance function.

Another maintenance function includes a corruption check function (step 93). The corruption check function provides a simple and effective strategy for recovering compromised files on the client and grid member disks. In one embodiment, a determination may be made as to whether a file is corrupt. The determination may be made by the user or the master/client program. The program may compare recomputed fingerprint values of a given file that were previously entered in the fingerprint database to determine if the file is corrupt. If the previous fingerprint does not match the new fingerprint and the file modification time has not changed, then the file has most likely become corrupted. Additionally, a database of pre-computed fingerprints for files contained in popular software products may be consulted. If the file name and possibly other characteristics match the named file in this data base, but the fingerprint differs, then the file may be considered corrupted. Additionally, a configured list of files may be specified for the grid, which asserts that all copies of such files should be identical. As an example, referring again to FIG. 3, a given file 70 shares a file name with file 80 however, their fingerprint values differ. Therefore, file 80 may be marked as corrupt and then repaired by copying file 70 over the corrupted file 80. The corrupted file 80 may be the result of an errant program or disk fault.

One consideration made during the corruption check maintenance function relates to determining which file is good and which is corrupt of a like file pair. In one embodiment, a file having an earlier file time may be designated as the good file and the later file as corrupt. Additionally, the fingerprint database may have an entry designating files as passing a virus scan or corruption inspection. Those files having the passing entry may be assumed to be good files for as long as their fingerprint does not change.

Another maintenance function includes a restoration function (step 94). The file restoration function provides a simple and effective strategy for restoring files on the client and grid member disks. In one embodiment, a determination may be made as to whether a file should be restored. The determination may be made by the user or the master/client program. A given file may be tagged for restoration from an archived copy. The tagged file may then be located by searching the archive, as known in the art. The tagged file may then be restored by copying the archived copy to a designated restoration site. In one embodiment, a user may restore an erased file by designating the file for restoration through master/client program interface. In another embodiment, the master program may check that each file has two copies stored on distinct disks. Thus, if either copy is lost, the existing copy may be used to recover the lost copy. The restoration function may be utilized to restore a portion of or the entire contents of a given disk.

In another embodiment, if a disk becomes damaged or inaccessible, a new replacement disk may be installed. The restoration function may determine which files existed on the prior damaged disk, tag these files, located the tagged files, and copy the same files from other locations on the grid, thereby restoring the content of the damaged disk drive. Some tagged files, however, need not be restored. For example, a damaged file should not be tagged and restored if the last operation on this file instance was to delete it. In such instances, the time of a file's deletion may be noted in the fingerprint database.

Another maintenance function considers client computer disk capacity (step 95). In one embodiment, a determination may be made as to the client disk capacity, as known in the art. The capacity may include the overall size of the disk as well as remaining disk space. The determination may be made by the user or the master/client program. The maintenance function may then be performed based on the capacity. For example, file restoration would only take place if the necessary disk space was available on a target disk; archived files copies would be stored on those disks with greater remaining disk space; and file maintenance procedures would not be required as often for smaller disk capacities. In one embodiment, the master/client program may notify the user of available disk space or when additional disk space should be liberated.

Another maintenance function considers file maintenance scheduling (step 96). In one embodiment, a determination may be made as to the optimal time to perform any file maintenance function. The determination may be made by the user or the master/client program. Furthermore, the determination may be made based on the activity database. The maintenance function or program function, such as fingerprint determination, may then be performed at the optimal maintenance time. For example, client computers may be idle during evening or nighttime hours therefore making those times ideal for performing maintenance functions. As such, the scheduling function provides means for performing maintenance functions during “off-peak” usage times. Considering optimal maintenance times may provide for unobtrusive function with minimal disruption in client computer performance.

In one embodiment, the maintenance functions are preferably scheduled at times of low client activity as indicated by the activity database. If unexpected client activity begins while a maintenance function is being performed, the maintenance function may be suspended, terminated, and/or rescheduled for a later time. The maintenance functions may be performed automatically when the client member is not active according to the activity database. However, if the client member is continuously active for more than a specified amount of time (e.g. one week), the maintenance function may be forced by corresponding scheduling parameters. The forced maintenance function is performed even though it may disrupt or degrade normal client member performance.

It is important to note that the figures and description illustrate specific applications and embodiments of the present invention, and is not intended to limit the scope of the present disclosure or claims to that which is presented therein. While the figures and description present an algorithm run on a master/client computer grid, the present invention is not limited to that format, and is therefore applicable to other computer network formats. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. Method of maintaining files on a computer grid comprising:
detecting at least one member of the computer grid;
determining a usage profile of the member;
determining a fingerprint for files stored on the member;
storing the fingerprint with an associated file name in a database; and
performing a maintenance function based on the database.

2. The method of claim 1 wherein the database comprises at least one file characteristic.

3. The method of claim 2 wherein the file characteristic is selected from a group consisting of a file location, a file time, and a file size.

4. The method of claim 1 further comprising identifying at least one exempt member wherein the exempt member is exempt from the maintenance function.

5. The method of claim 1 wherein performing the maintenance function comprises:
determining a storage file; and
archiving the storage file.

6. The method of claim 1 wherein performing the maintenance function comprises:
determining an unnecessary file based on the database; and
deleting the unnecessary file.

7. The method of claim 1 wherein performing the maintenance function comprises:
determining a corrupt file based on the fingerprint; and
repairing the corrupt file.

8. The method of claim 1 wherein performing the maintenance function comprises:
determining a tagged file;
locating the tagged file; and
restoring the tagged file.

9. The method of claim 1 wherein performing the maintenance function comprises:
determining a member disk capacity; and
performing the maintenance function based on the member disk capacity.

10. The method of claim 1 wherein performing the maintenance function comprises:
determining an optimal maintenance time of the member based on the usage profile; and
performing the maintenance function at the optimal maintenance time.

11. A computer usable medium including a program for maintaining files on a computer grid comprising:
computer readable program code for detecting at least one member of the computer grid;
computer readable program code for determining a usage profile of the member;
computer readable program code for determining a fingerprint for files stored on the member;
computer readable program code for storing the fingerprint with an associated file name in a database; and
computer readable program code for performing a maintenance function based on the database.

12. The computer readable program code of claim 11 wherein the database comprises at least one file characteristic.

13. The computer readable program code of claim 12 wherein the file characteristic is selected from a group consisting of a file location, a file time, and a file size.

14. The computer readable program code of claim 11 further comprising identifying at least one exempt member wherein the exempt member is exempt from the maintenance function.

15. The computer readable program code of claim 11 wherein performing the maintenance function comprises:
determining a storage file; and
archiving the storage file.

16. The computer readable program code of claim 11 wherein performing the maintenance function comprises:
determining an unnecessary file based on the database; and
deleting the unnecessary file.

17. The computer readable program code of claim 11 wherein performing the maintenance function comprises:
determining a corrupt file based on the fingerprint; and
repairing the corrupt file.

18. The computer readable program code of claim 11 wherein performing the maintenance function comprises:
determining a tagged file;
locating the tagged file; and
restoring the tagged file.

19. The computer readable program code of claim 11 wherein performing the maintenance function comprises:
determining a member disk capacity; and
performing the maintenance function based on the member disk capacity.

20. The computer readable program code of claim 11 wherein performing the maintenance function comprises:
determining an optimal maintenance time of the member based on the usage profile; and
performing the maintenance function at the optimal maintenance time.
